(19) United States
(12) Patent Application Publication
(10) Pub. No.: US 2009/0172441 A1
(43) Pub. Date: Jul. 2, 2009

(54) HARDWARE PROACTIVE IMPLEMENTATION FOR ACTIVE MODE POWER CONTROL OF PLATFORM RESOURCES

(76) Inventors: Krishna Kant, Portland, OR (US); James W. Alexander, Hillsboro, OR (US)

Correspondence Address: INTEL CORPORATION;c/o CPA Global, P.O. BOX 52050, MINNEAPOLIS, MN, 55402, US

(21) Appl. No.: 11/967,912

(22) Filed: Dec. 31, 2007

(51) Int. Cl. G06F 1/00

(52) U.S. Cl. 713/323

(57) ABSTRACT

In some embodiments, estimating a duration of an idle period gap of a lower power state of a resource by exponentially smoothing successive idle period gaps. Other embodiments are described and claimed.

### TECHNICAL FIELD

The inventions generally relate to hardware proactive implementation for active mode power control of platform resources.

### BACKGROUND

The basic (or uncoupled) power control of a resource (for example, a link, DRAM rank, processor core, etc.) typically proceeds in a manner that uses a low power state. When the resource is found to remain idle for some period of time, it is transitioned to a low power state where it stays either until the arrival of new requests for the resource or until some predetermined time expires.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates power states according to some embodiments of the inventions.

FIG. 2 illustrates simulation results according to some embodiments of the inventions.

FIG. 3 illustrates simulation results according to some embodiments of the inventions.

### DETAILED DESCRIPTION

Some embodiments of the inventions relate to hardware proactive implementation for active mode power control of platform resources.

In some embodiments, estimating a duration of an idle period gap of a lower power state of a resource by exponentially smoothing successive idle period gaps.

In some embodiments, a reduction is made in power consumption of components of a platform (e.g., links, memory, processing cores, etc.) by opportunistically putting them in a low power state. A component can be put in the low power state when not in use (generally, when the queue of requests for it drains out), and it must be brought back to the normal power state before the next use. For example, a link can be put in a low power state when there is nothing to transmit, but must transition to a normal power state on or prior to the arrival of a new transmit request. Both entry into the low power state and exit out of it take some finite amount of time, which is henceforth referred to as a “cost” or “latency”. If the exit from the low power state is affected when a new request for the component arrives, the new request will encounter the full exit latency. This additional latency generally results in degraded performance. Hence, the purpose of the power control algorithm is to decide when to transition the component into and out of the low power state so that it can fulfill two conflicting goals: (a) maximize power savings, and (b) minimize latency (or performance) impact. The word “resource” is used herein for any independently power controlled component.

The uniqueness of the implementation according to some embodiments is that it is proactive in nature, in that it predicts the duration of non-use of the resource and attempts to transition to the normal power state ahead of the new request arrival. At the same time, the implementation has very low complexity and is appropriate for direct hardware (HW) implementation and high speed operation. In some embodiments, the proactive nature of the implementation is especially useful in combating the effects of rather high entry and exit latencies that are currently encountered in some of the key platform resources for which it is intended.

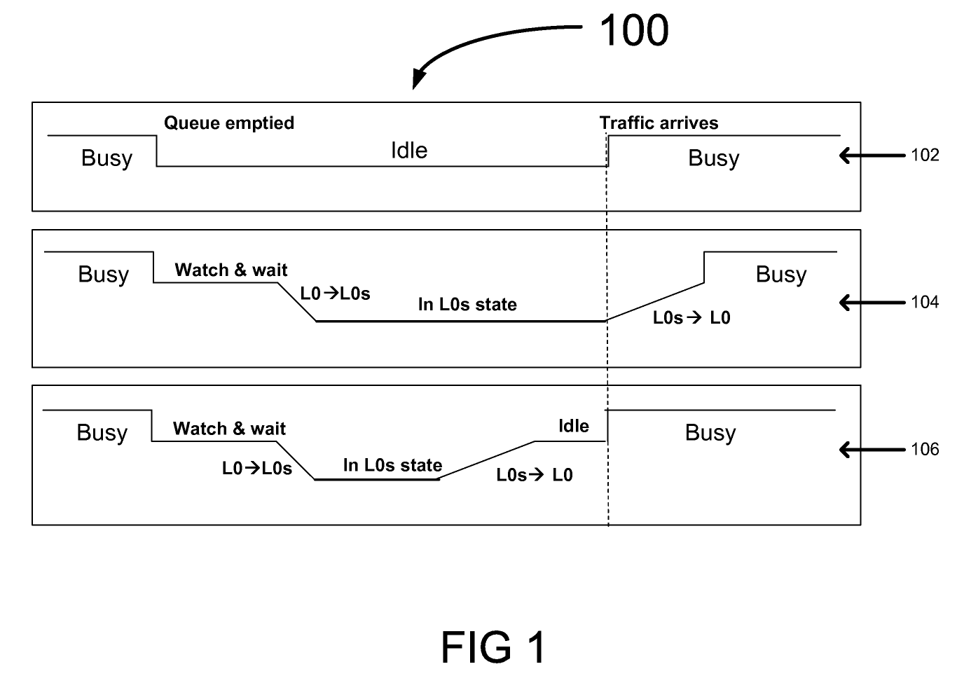

FIG. 1 illustrates three power state timing diagrams 100, including power state diagram 102, power state diagram 104, and power state diagram 106. Diagram 102 illustrates the operation of a resource without any power control. In this case, the resource continues to burn power at the full rate during the entire idle period. Diagrams 104 and 106 illustrate two forms of power control. In each case, the illustration uses terminology commonly employed for links where L0 refers to a normal power state and L0s is the first low power state. It is noted that many resources (including, for example, a link) can have multiple power states, however, the description herein focuses on single low power state control. Diagram 104 shows a “reactive” exit wherein the link stays in L0s state until the traffic arrives and then starts the L0s→L0 transition process. Since the duration of the idle period can vary substantially, the L0→L0s transition is nearly always preceded by a “watch & wait” period which we also refer to herein as a runway. Runway control is an integral part of any power control algorithm. Diagram 106 illustrates an implementation with proactive exit wherein the “gap” (or duration of the idle period) is predicted and used for a proactive exit to the normal L0 state. The quality of the gap prediction is the key to a proactive implementation. If the predicted gap is too small, the implementation will transition to the L0 state too soon, and will thus be unable to maximize power savings. On the other hand, if the predicted gap is too large, the link will be unable to move to the L0 state by the time the new traffic arrives. Consequently, the new traffic will encounter additional delay which causes suboptimal performance.

In some embodiments, the implementation can be applicable to one or more of the following (but not limited to the following: (a) Power control of processor-memory links (Quickpath™ and its successors), (b) Power control of industry standard PCI-E links connecting IO devices to the IO hub, (c) Power control of derivatives of PCI-E used in the chipset (e.g., DMI), (d) Power control of FBD links used with FBD memory, (f) All forms of CKE (clock-enable) control of DRAM power, which may operate at the level of DRAM ranks, DIMMs or memory channels, and (g) C-state control of individual CPU cores.

In some embodiments, an ESA (exponential smoothing algorithm) is used to estimate the gap via an exponential smoothing of successive gaps. To explain exponential smoothing, let Gₙ denote the running estimate of the gap size at n^{th} step and let gₙ denote the actual gap encountered. Then the running estimate Gn is estimated as follows:

Gₙ=(1−α)Gₙ₋₁+αgₙ

where αε[0 . . . 1] is the smoothing constant which specifies how much weight a new sample gets.

Successive gaps can vary widely and a simple exponentially smoothed estimate is inadequate. Instead, ESA uses a biased exponential estimate specified as follows:

if gₙ≦Gₙ₋₁
then Gₙ=(1−α)Gₙ₋₁+αgₙ
else Gₙ=(1−β)Gₙ₋₁+βgₙ
   where β<α. This means that smaller gaps affect the gap more aggressively than larger ones. Consequently, if small gaps are interspersed with relatively infrequent large gaps (a typical heavy-tailed behavior observed in practice), the large gaps will not perturb the estimate substantially and proper operation with respect to small gaps will be maintained. Both α and β are parameters of the algorithm but are not intended to be user selectable.

In some embodiments, R₀ denotes the runway (or wait and watch period) and ηₑ and ηₓ denote, respectively, the entry and exit costs. Both ηₑ and ηₓ are fixed and known for a given resource, and R₀ is known when preparing to go into low power mode. Then, the predicted residence time in low power state, denoted L, is given by:

Lₙ=Gₙ−R₀−ηₑ−ηₓ

If the predicted Lₙ is negative or too small, the algorithm may decide to change the runway R₀ for subsequent gaps as discussed below.

In some embodiments, ESA is actually a two-phase algorithm and uses a separate runway in each phase. The first phase is as shown at 106 in FIG. 1 where the algorithm attempts to exit proactively. The algorithm will monitor request arrival in the queue as well, and if exit has not been initiated by the request arrival time, initiate a reactive exit. On the other hand, if no request arrives for a significant amount of time after the exit, ESA will enter the low power state again, but for a reactive exit. The idle time before the second entry can be regarded as the second runway, henceforth denoted as R₁. This “phase 2” of ESA uses reactive exit since it is catering to unusually long gaps that cannot be predicted accurately. The two phase nature of ESA allows it to work well for bursty traffic and for heavy-tailed gap size distributions.

In some embodiments, the control of runways R₀ and R₁ is an integral part of ESA. Several ways of varying R₀ were attempted, of which two are explicitly stated herein and lead to two different flavors of ESA. The simpler version (referred to as basic ESA) is most appropriate for HW implementation and controls R₀ as follows:

if Lₙ<1 then R₀=W₀(1+Limit/8) else R₀=W₀

where W₀=(ηₑ+ηₓ)/² is the minimum runway setting and Limit is the only user-settable control parameter used by ESA. The main idea of the above equation is to increase the wait and watch period if our current estimate indicates that we might be going into the low power state for too short a period. The runway R₁ for the second phase of basic ESA is set as R₁=W₀×Limit. Notice that R₁ is substantially larger than R₀ so that low power mode entry in the second phase is very infrequent. This is essential in order to effectively control the latency impact of the reactive exit.

The advanced ESA version bases its R₀ on an estimate of the current utilization of the resource. The utilization is estimated from exponentially smoothed estimates of the gaps (or off times) as well as busy periods (or on times). The on-time estimate, henceforth denoted as Bₙ, uses a single smoothing constant γ, i.e.,

Bₙ=(1−γ)Bₙ₋₁+γbₙ

where bₙ is the nth busy period. With this, the resource utilization U can be estimated as

Uₙ=Bₙ/(Bₙ+Gₙ)

The smoothing constant γ is chosen as roughly the geometric mean of α and β. The runway R₀ is then made roughly proportional to the utilization Uₙ. It is noted that there is no need for an explicit division operation, and even the multiplication can be avoided by keeping the proportionality approximate. Such a setting would make the algorithm more cautious at high utilizations (so as to minimize latency impact of wrongful entry into low power state) and more aggressive at low utilizations (so as to maximize time spent in low power state).

In some embodiments, the parameter Limit controls the tradeoff between power savings and latency impact of the algorithm. It turns out that it is impossible to achieve both high power savings and low latency impact. The Limit parameter allows the algorithm to operate in the desired region.

In almost all the contexts mentioned above (with the possible exception of processor core C-state control), the algorithm must operate at very high speed and must be easily implemented in hardware. In order to facilitate this, both α and β must be chosen as negative powers of 2. This is generally an adequate granularity in practice. Similarly, Limit must be a power of 2. With this, all computations can be implemented with only integer add, subtract and shifts. The other important issues are that of precision and range. The gap and busy period measurements are typically in the units of an underlying clock, and may have a limited range. For example, if the gap sizes are limited to 65535 clock units, the exponential smoother will be insensitive to larger gaps. The calculations required for exponential smoothing must be done using somewhat larger number of bits in order to control truncation errors. It is found that an additional 4-bits of precision is adequate for implementing ESA well.

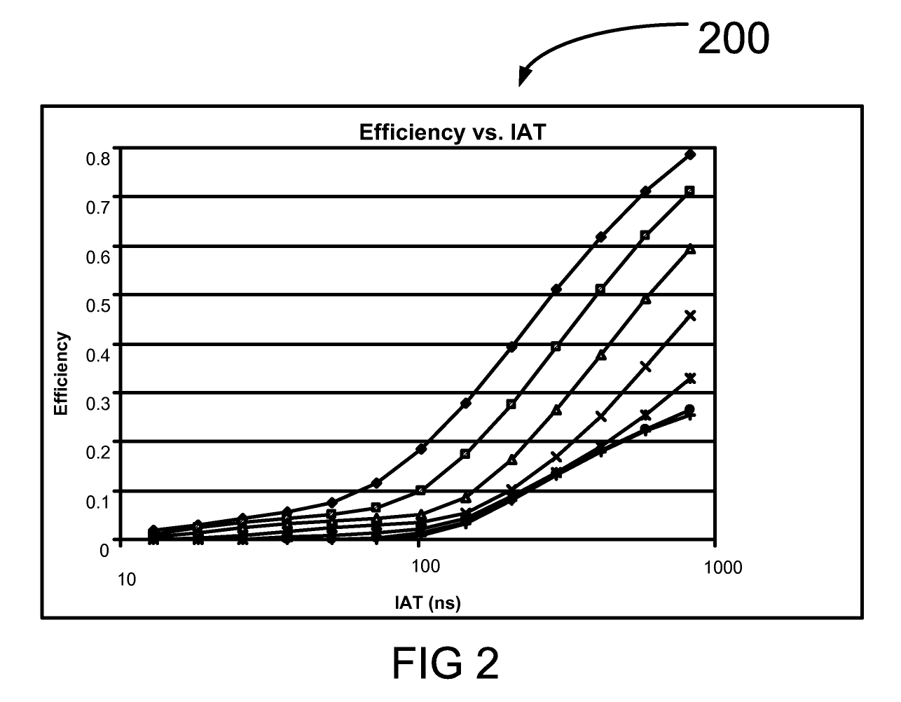

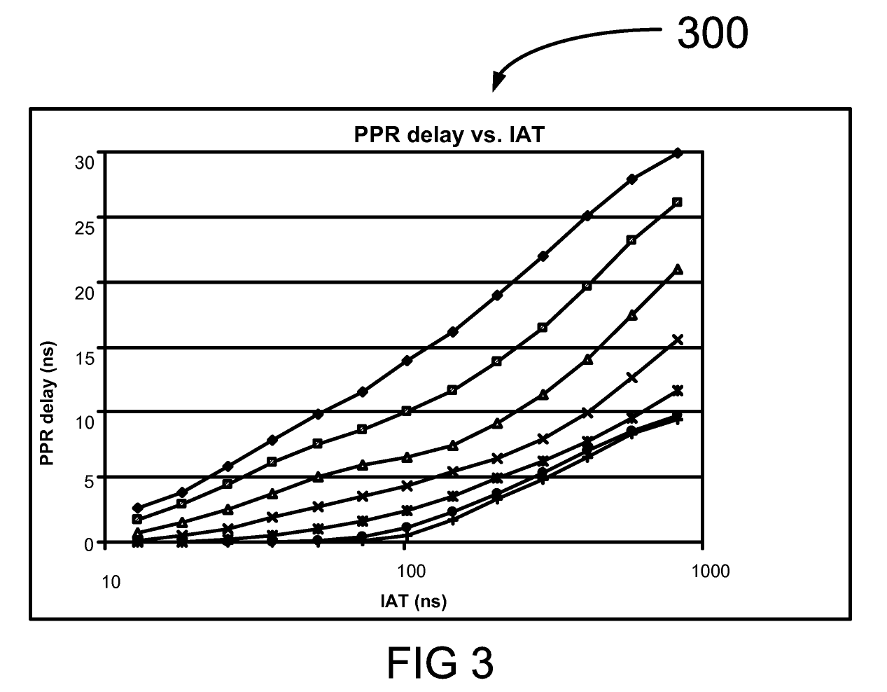

Both simple and advanced ESA algorithms have been evaluated via detailed simulations as illustrated, for example in FIG. 2 and in FIG. 3. The fixed parameters used were a=½ and b= 1/16. The Limit parameter depends on the resource type. A hardware implementation of simple ESA has also been done and takes only 5K gates, for example. At this gate count, both the area cost and the power consumption of simple ESA are negligible even when considering the fact that multiple copies must be implemented for various resources or independently controllable portions of a given resource (e.g., one ESA per 4 lane groups of PCIE).

Detailed simulations have been used to select Limit parameter for Quickpath, PCIE and CKE applications of ESA. FIG. 2 and FIG. 3 illustrate the results for 6.4 GT/sec Quickpath. The current best estimates for the entry and exit costs for Quickpath are 10 ns and 25 ns respectively; so the total cost is about an order of magnitude larger than the typical link transmission time. This is where a proactive algorithm such as ESA can provide a respectable power savings without adding excessive latencies to the memory access path. Of course, a reactive algorithm can achieve higher power savings at the same link utilization level; however, it will have a comparatively larger latency impact.

The x-axis in both graphs 200 and 300 of FIG. 2 and FIG. 3 is the inter-arrival time (IAT) of requests in ns. An IAT of 10 corresponds to about 25% utilization for Quickpath (and hence 1000 ns corresponds to 0.25% utilization). The two graphs 200 and 300 show two important parameters for the algorithm: (a) Efficiency, or the fraction of time the algorithm can keep the link in L0s state, and (b) Average additional delay encountered by the requests due to power control. It is seen that Limit values of 8 or 16 provide the best compromise between latency and efficiency.

In some embodiments, a proactive approach is used that is crucial to obtaining power savings without a large latency impact when the low power state entry and exit costs are large. The latter situation applies at least to Quickpath, PCIE, FBD, and is unlikely to change in near future. The present inventors believe that the current state of the art is a reactive algorithm (for example, for Quickpath and PCIE). The parameters for this algorithm have been set such that the algorithm will not come into effect except at extremely low utilizations. This is because of its latency impact concerns. In contrast, in some embodiments the proactive algorithm prescribed here can be used much more aggressively.

In some embodiments, operational statistics and support interfaces for an external power control engine (e.g., power control unit or PCU) may be used to control the ESA engine. In some embodiments, the ESA is on a landing zone (runway) for power control of Quickpath (CSI), DMI, PCIE, and/or CKE. ESA can also be used in some embodiments for other applications (for example, for C-state control of processor cores).

In some embodiments, the invention may be used by other vendors in a variety of power control contexts. This includes use, for example, by processor vendors, as well as use by other HW vendors (e.g., graphics HW manufacturers) and OS vendors (for OS directed power control of devices). In some embodiments, any power control algorithm may be implemented that uses some variant of exponential smoothing to predict idle duration, and may be used to do power control.

Although some embodiments have been described herein as being included in particular implementations, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
estimating a duration of an idle period gap of a lower power state of a resource by exponentially smoothing successive idle period gaps.

2. The method of claim 1, further comprising calculating a biased exponential estimate to exponentially smooth the successive idle gap periods.

3. The method of claim 2, further comprising calculating the biased exponential estimate such that smaller idle gap periods have a greater effect on the biased exponential than larger idle gap periods.

4. The method of claim 1, further comprising attempting to proactively exit an idle period gap.

5. The method of claim 4, further comprising proactively exiting the idle period gap.

6. The method of claim 5, further comprising entering an idle period gap of the low power state after proactively exiting the idle period gap if no request arrives for an amount of time after the proactive exiting.

7. The method of claim 6, further comprising preparing for a reactive exiting of the idle period gap after entering of the idle period gap after the proactive exiting.

8. The method of claim 1, further comprising increasing a wait and watch period that is prior to entering an idle period gap of the low power state if current estimates indicate that the idle period gap about to be entered will be too short of a period of time.

9. The method of claim 1, further comprising estimating a current utilization of the resource to determine a wait and watch period that is prior to entering an idle period gap of the low power state.

10. The method of claim 9, wherein the estimating of the current utilization of the resource is estimated from exponentially smoothed estimates of idle period gaps as well as busy periods.

11. An apparatus comprising:
a controller to estimate a duration of an idle period gap of a lower power state of a resource by exponentially smoothing successive idle period gaps.

12. The apparatus of claim 11, the controller to calculate a biased exponential estimate to exponentially smooth the successive idle gap periods.

13. The apparatus of claim 12, the controller to calculate the biased exponential estimate such that smaller idle gap periods have a greater effect on the biased exponential than larger idle gap periods.

14. The apparatus of claim 11, the controller to attempt to proactively exit an idle period gap.

15. The apparatus of claim 14, the controller to proactively exit the idle period gap.

16. The apparatus of claim 15, the controller to enter an idle period gap of the low power state after proactively exiting the idle period gap if no request arrives for an amount of time after the proactive exiting.

17. The apparatus of claim 16, the controller to prepare for a reactive exiting of the idle period gap after entering of the idle period gap after the proactive exiting.

18. The apparatus of claim 11, the controller to increase a wait and watch period that is prior to entering an idle period gap of the low power state if current estimates indicate that the idle period gap about to be entered will be too short of a period of time.

19. The apparatus of claim 11, the controller to estimate a current utilization of the resource to determine a wait and watch period that is prior to entering an idle period gap of the low power state.

20. The apparatus of claim 11, the controller to estimate the current utilization of the resource from exponentially smoothed estimates of idle period gaps as well as busy periods.
